(19) United States
(12) Patent Application Publication
(10) Pub. No.: US 2009/0272463 A1
(43) Pub. Date: Nov. 5, 2009

(54) Mortising Jig With Extensions

(75) Inventor: Darrin E. Smith, Barrie (CA)

Correspondence Address: SENNIGER POWERS LLP, 100 NORTH BROADWAY, 17TH FLOOR, ST LOUIS, MO, 63102, US

(73) Assignee: JESSEM TOOL COMPANY, Barrie (CA)

(21) Appl. No.: 12/434,427

(22) Filed: May 1, 2009

Related U.S. Application Data
(60) Provisional application No. 61/050,036, filed on May 2, 2008.

(51) Int. Cl. B27C 5/00

(52) U.S. Cl. 144/144.52

(57) ABSTRACT

A jig for cutting a mortise in a workpiece using a drilling tool having a mortising drill bit. The jig includes a base and a guide plate mounted on the base for movement relative to the base. A guide assembly locates the drilling tool. The guide assembly includes at least one rail supported by the guide plate. A guide is mounted on the rails for movement along the rails relative to the guide plate. The guide has an opening therein receiving and positioning the drilling tool. A bushing within the opening in the guide is mounted on the guide for rotation relative to the guide plate. A guide actuator includes a lever operatively mounted on the guide plate and a link connecting the lever to the guide whereby rocking the lever produces linear reciprocating motion of the guide on the rails.

### FIELD OF THE INVENTION

The present invention generally relates to jigs and more particularly to jigs for cutting mortises in workpieces.

### BACKGROUND OF THE INVENTION

One well known type of device in this field is a drilling jig. This type of mortising jig uses a standard drill to produce individual dowel joints or a series of adjacent holes which overlap. In the case of the drill jigs which produce the overlapping holes, an additional tool (i.e., chisel) is needed to finish the mortise. As a result, these jigs are inefficient.

Additionally, some mortising jigs of the prior art allow for guided movement of the drilling tool. Typically, these jigs include a carriage or guide which receives the drilling tool and is configured to move in a reciprocating motion for producing a mortise in the workpiece. These jigs, however, are often large, cumbersome or difficult to manipulate. Some jigs in the prior art further provide limited adjustment for altering the size and location of the mortise in the workpiece. Limitations arise in these jigs in accommodating multiple workpiece and workspace configurations. Thus, there is a need for a mortising jig that enjoys a faster and easier operation during the mortise cutting process.

### SUMMARY OF THE INVENTION

In one aspect of the present invention, a jig for cutting a mortise in a workpiece using a drilling tool having a mortising drill bit generally comprises a guide plate and a guide assembly for locating the drilling tool. The guide assembly includes at least one rail supported by the guide plate and a guide mounted on the rails for movement along the rails relative to the guide plate. The guide has an opening therein for receiving and positioning the drilling tool. The guide assembly further includes a bushing within the opening in the guide for rotation relative to the guide plate with the mortising drill bit of the drilling tool.

In another aspect, a jig for cutting a mortise in a workpiece using a drilling tool having a mortising drill bit generally comprises a guide plate and a guide assembly for locating the drilling tool. The guide assembly includes at least one rail supported by the guide plate and a guide mounted on the rails for movement along the rails relative to the guide plate. The guide has an opening therein for receiving and positioning the drilling tool. The jig further comprises a guide actuator with a lever pivotally mounted on the guide plate and a link connecting the lever to the guide whereby rocking of the lever produces linear reciprocating motion of the guide on the rail.

In yet another aspect, an adjustable jig for cutting a mortise in a workpiece using a drilling tool having a mortising bit generally comprises a base and an adjustable guide plate mounted on the base for movement of the guide plate relative to the base. The guide plate is also adapted for releasable attachment to the base at selected locations whereby the guide plate and the guide assembly can be positioned with respect to the base. The adjustable jig further comprises a guide assembly supported by the adjustable guide plate for locating the mortising drill bit of the drilling tool. The guide assembly includes rails mounted on the guide plate and a guide mounted on the rails for movement along the rails relative to the guide plate. The guide has an opening therein for receiving and positioning the mortising drill bit. The guide plate is mounted on the base for movement of the guide plate relative to the base and adapted for releasable attachment to the base at selected locations whereby the guide plate and guide assembly can be positioned with respect to the base.

Other objects and features will be in part apparent and in part pointed out hereinafter.

### BRIEF DESCRIPTION OF THE DRAWINGS

FIG. 1 is a front perspective of a mortising jig and an extension assembly;

FIG. 2 is a back perspective the mortising jig and extension assembly;

FIG. 3 is a front perspective of the mortising jig;

FIG. 4 is a left side elevation of the mortising jig;

FIG. 5 is a front elevation of the mortising jig;

FIG. 6 is a top view of the mortising jig;

FIG. 7 is a front perspective of a base of the mortising jig;

FIG. 8 is a back perspective of the base;

FIG. 9 is left side view of the base;

FIG. 10 is a perspective of a squaring plate of a squaring assembly of the jig;

FIG. 11 is a top perspective of a guide plate of the jig;

FIG. 12 is a top perspective of the guide plate with a vacuum hood attached and partially broken away;

FIG. 13 is a bottom perspective of the guide plate;

FIG. 14 is a perspective of a guide of a guide assembly of the jig;

FIG. 15 is a perspective of a bushing of the guide assembly;

FIG. 16 is a section of the guide assembly;

FIG. 17 is a cross section of the guide assembly with the bearings and bushing removed;

FIG. 18 is an exploded perspective of the guide assembly;

FIG. 19 is an exploded perspective of a stop and rails of the jig;

FIG. 20 is a bottom perspective of the vacuum hood;

FIG. 21 is a front perspective of an extension of the extension assembly;

FIG. 22 is a back perspective of the extension;

FIG. 23 is a left side view of the extension;

FIG. 24 is a fragmentary front perspective of the extension assembly with a workpiece support thereof exploded; and

FIG. 25 is the perspective of FIG. 24, but from the back.

Corresponding reference characters indicate corresponding parts throughout the drawings.

### DESCRIPTION OF THE PREFERRED EMBODIMENTS

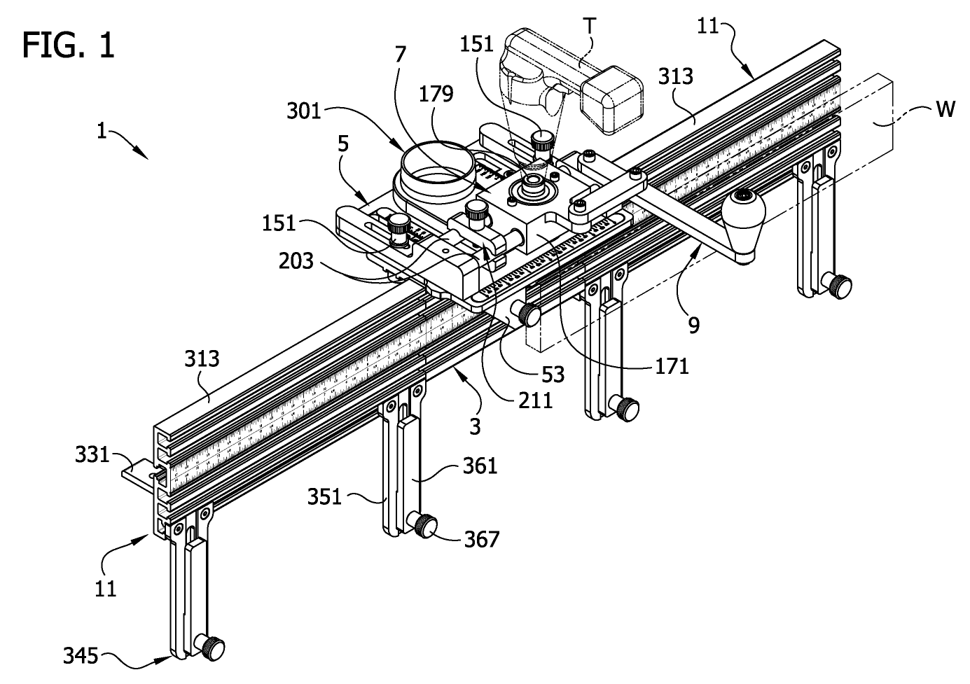

Referring now to the drawings and in particular to FIG. 1, a mortising jig, generally indicated at 1, for use in cutting mortises in a workpiece W (shown in phantom) is illustrated. The jig 1 includes a base 3 and a guide plate 5 slideably attached to the base, the two providing a surface for positioning the workpiece W. The guide plate 5 can be adjusted relative to the base 3 to locate the mortise in a transverse direction. A guide assembly, generally indicated at 7, is attached to the guide plate and locates a drilling tool T (shown in phantom) over the workpiece W. An actuator, generally indicated at 9, operatively connects to the guide assembly 7 and the guide plate 5 to move the guide assembly with respect to the guide plate for cutting the mortise in the workpiece W with the drilling tool T. An extension assembly 11 is fixed adjacent to the base 3.

The mortising jig 1 is of the type primarily used for wood working. However, it is envisioned that other materials can be worked by this apparatus. The jig 1 of the present invention is classified as a drilling jig because it can use a standard drill with a mortising drill bit attachment rather than a router to cut the mortise. As will be described in greater detail later, the guide assembly 7 is configured to receive and guide the drilling tool T during the operation of the jig 1.

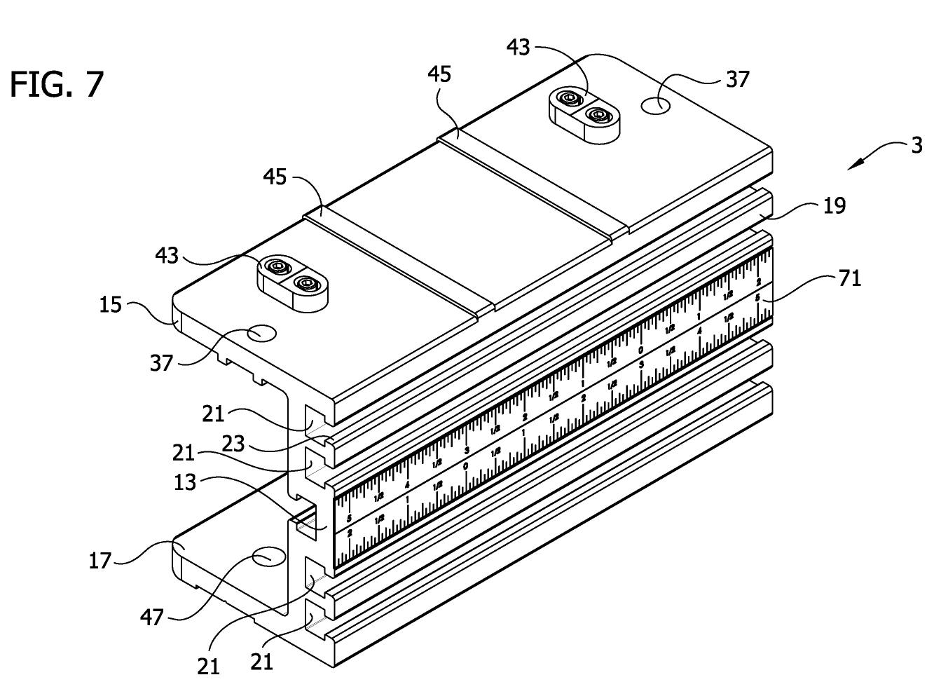

Referring also to FIGS. 7-9, the base 3 is generally C-shaped having a middle section 13, a top section 15 and a bottom section 17. The middle section 13 has a front face 19 with vertically spaced channels 21 extending lengthwise across the middle section. FIG. 7 shows four channels 21 but any number of channels is contemplated as being within the scope of the present invention. Each channel 21 has a lip 23 extending partially over the channel, the function of which will be explained in greater detail later.

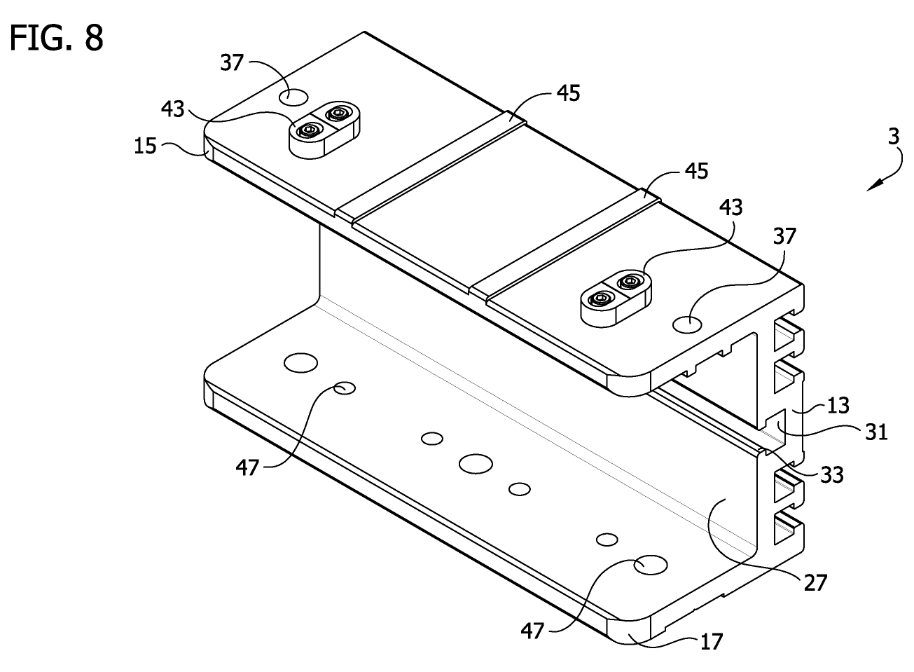

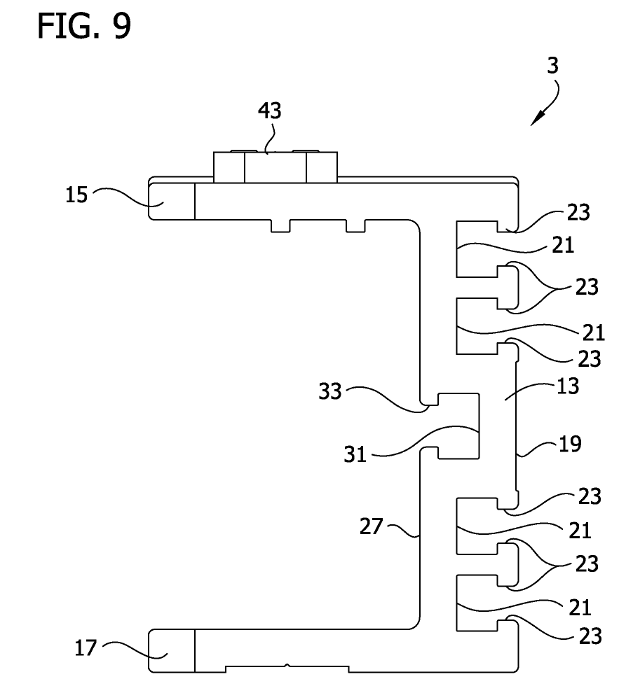

A back face 27 of the middle section 13 has a channel 31 with a lip 33 extending partially over the channel (see FIGS. 8 and 9). The channel 31 extends longitudinally across the full length of the middle section 13. Only one channel is shown in the illustrated embodiment, however, multiple channels could be provided within the scope of the present invention. The top section 15 has a pair of holes 37 located at opposite ends, along the length of the base 3. The holes 37 pass from a top face to a bottom face of the top section and are used to attach the guide plate 5 to the base 3.

The top face of the top section 15 has a pair of indicator blocks 43 attached thereto and positioned in close relation to the holes 37. The top face of the top section 15 also has a pair of shoulders 45 positioned near the center of the top section 15 and spaced apart from each other. The guide plate 5 slides on these shoulders 45 when moved with respect to the base 3. The bottom section 17 has a series of apertures 47 of different diameters. The apertures 47 are configured for attaching the base 3 to a workbench (not shown). The base 3, in the preferred embodiment, is made of aluminum. It is envisioned that other materials (e.g., other metals, plastic, wood, etc.) would be suitable and within the scope of the invention.

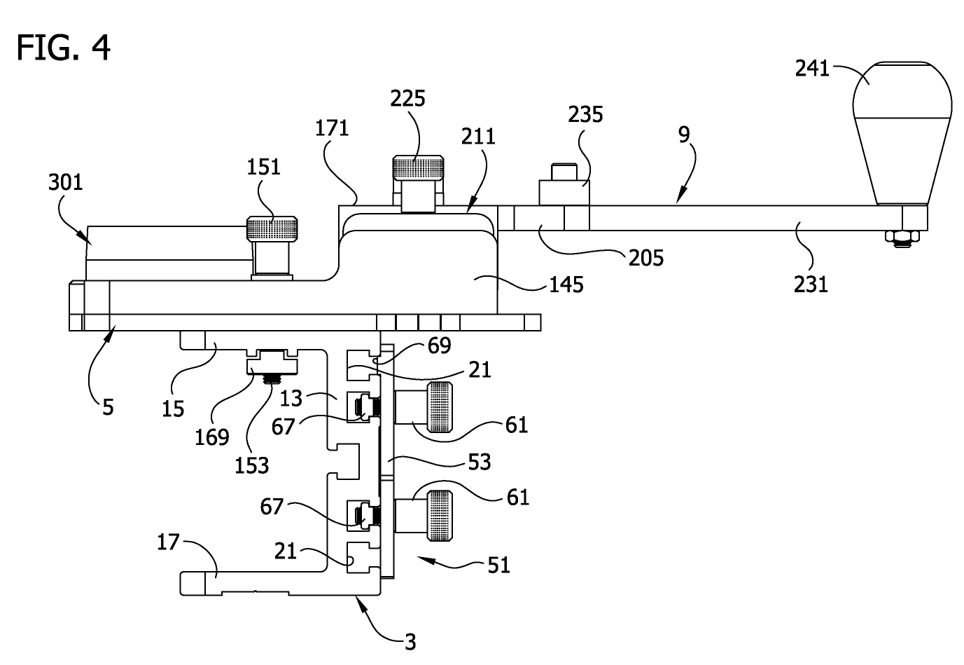

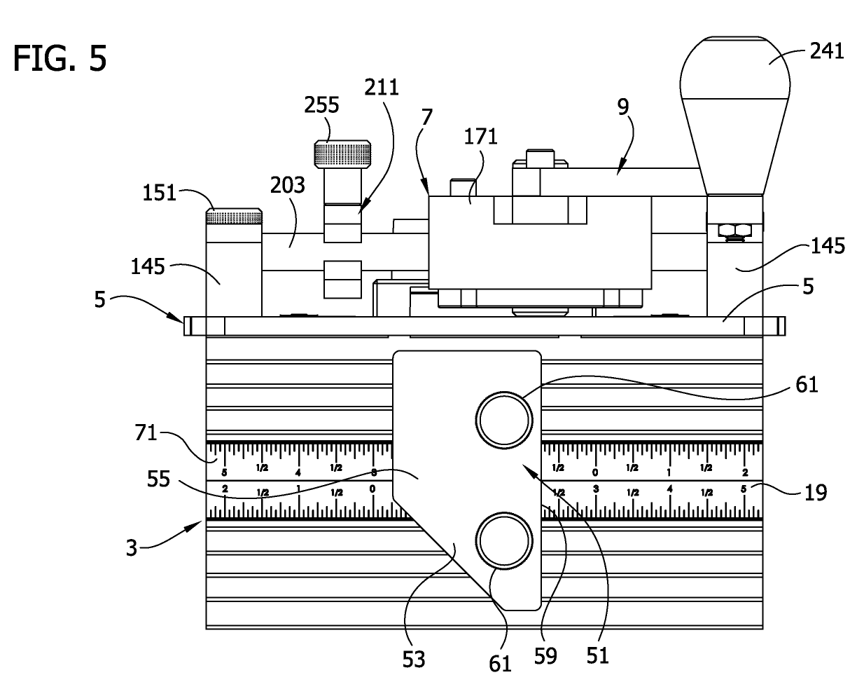

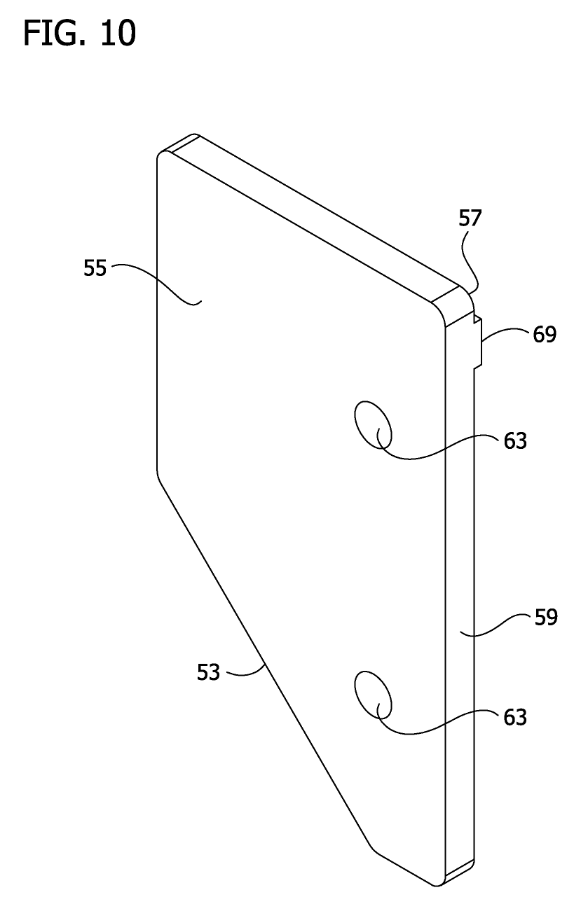

To aid in positioning the workpiece W against the middle section 13 of the base 3, a squaring assembly 51 is provided (see FIGS. 4, 5 and 10). The squaring assembly includes a squaring plate 53 with an outer face 55, an inner face 57 and an alignment edge 59 connecting the two faces along one side. Threaded squaring knobs 61 attach the squaring plate 53 to the base 3 through holes 63 in the squaring plate 53. The threaded end of the squaring knobs 61 have an attachment nut 67 configured to slide inside and be retained within the channels 21 on the base 3. A second end of the squaring knob 61 extends out from the outer face 55 of the squaring plate 53 for grasping and turning the knob. A rib 69 on the back face of the squaring plate is received in the uppermost channel 21 and slides in the channel. The interaction between the rib 69 and the channel 21 helps to maintain a precise vertical orientation of the alignment edge 59. The alignment edge 59 engages and “squares” the workpiece W. A locating scale 71 on the base 3 indicates where the alignment edge 59 of the squaring plate 53 (and thus the workpiece W) is located in the jig 1. Although the figures show a preferred embodiment of a squaring assembly, it is contemplated that other suitable configurations for the squaring plate and squaring knobs can be used within the scope of the present invention.

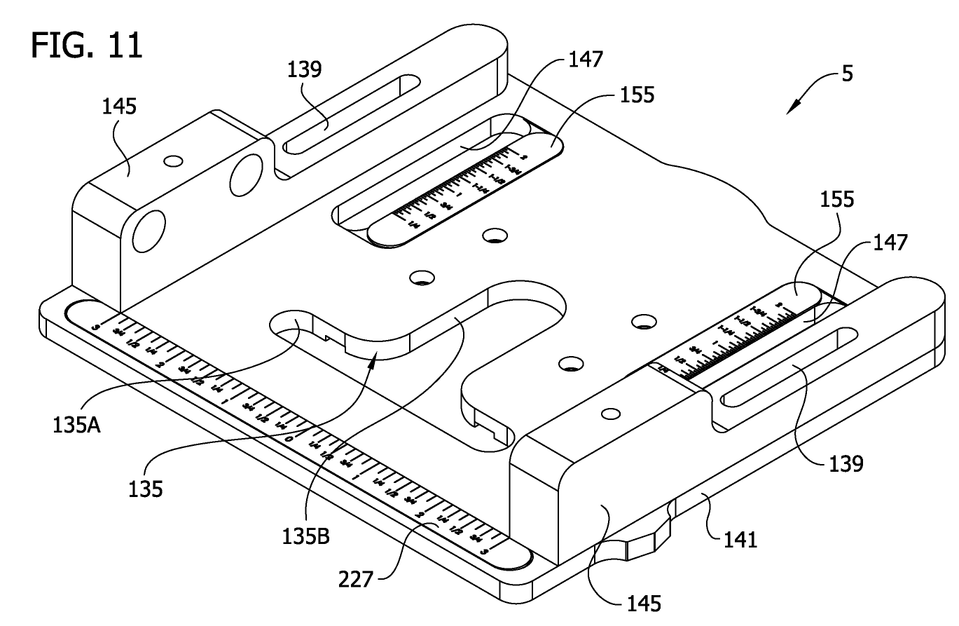

Referring to FIGS. 11-13, the guide plate 5 is generally rectangular in shape having a top face and a bottom face. An inverted T-shaped drill aperture 135 is located in the top face of the guide plate 5. The drill aperture 135 includes a drill bit portion 135A for receiving a drill bit through the guide plate 5, and a vacuum portion 135B used to remove shavings. Adjustment slots 139 are located adjacent side edges 141 of the guide plate 5 and extend in a front-to-back direction of the guide plate. FIG. 11 shows a portion of the guide plate 5 extending upward from the top face of the guide plate forming a slotted block 145 including the slot 139. It is understood that the adjustment slots could have other configurations within the scope of the invention.

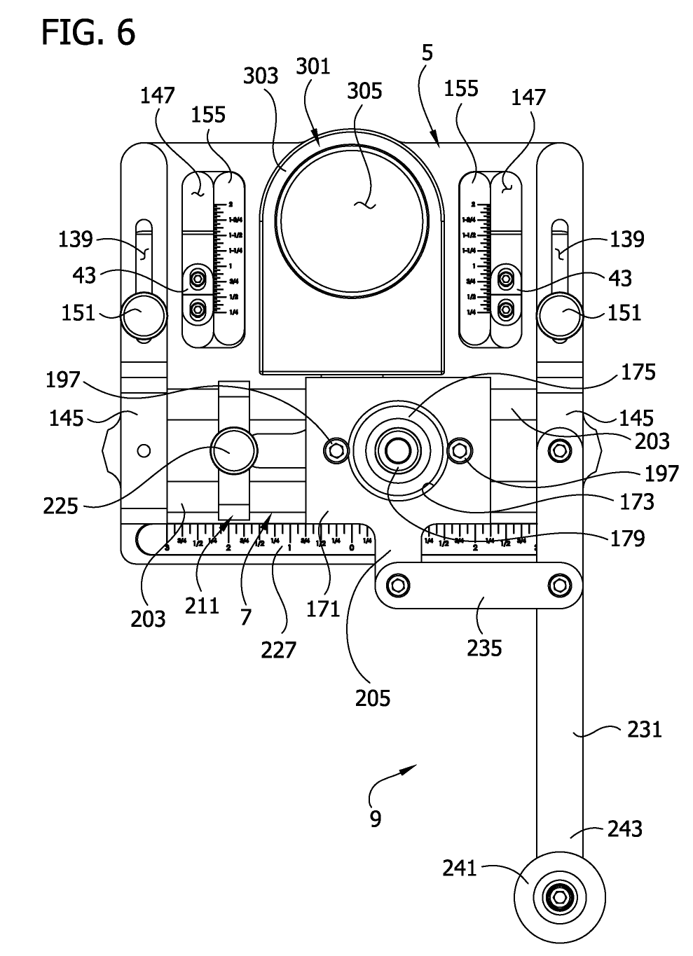

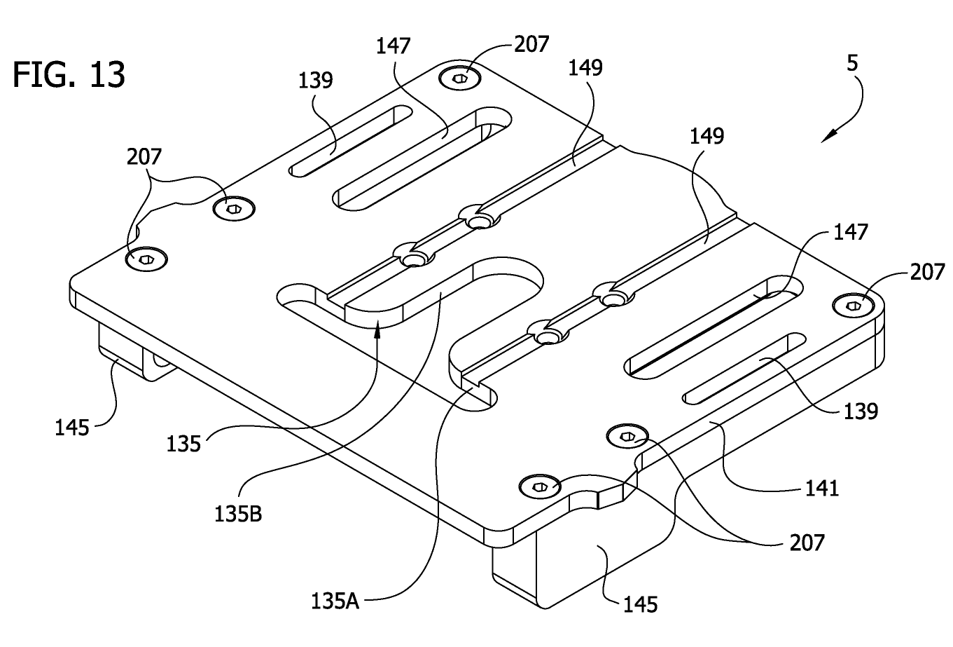

A pair of indicator slots 147 are positioned inside the adjustment slots 139. The indicator slots 147 are located near a back edge of the guide plate. The indicator slots 147 are sized and shaped to receive the indicator blocks 43 so that the indicator blocks can slide within the indicator slots when the guide plate 5 is attached to the base 3 (see, FIG. 6). The bottom face of the guide plate 5 has a pair of channels 149 extending from the back edge 143 to the drill aperture 135 and positioned to match the shoulders 45 on the base 3 when the guide plate is attached to the base (see, FIG. 13). The channels 149 are sized and shaped for receiving the shoulders 45 to guide the movement of the guide plate 5 relative to the base 3. This movement of the guide plate 5 with respect to the base 3 adds an adjustment capability to the jig 1.

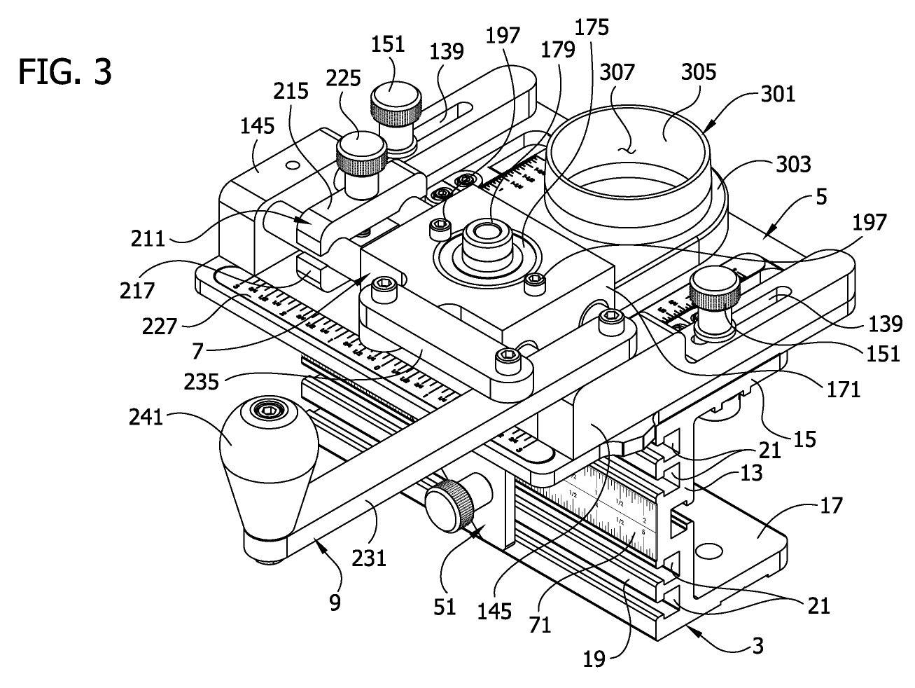

Referring to FIGS. 3-6, an adjustment assembly comprising a pair of set screws 151 provides releasable and selective positioning of the guide plate 5 relative to the base 3. Set screws 151 pass through the adjustment slots 139 and the holes 37 in the top section 15 of the base 3 and mate with nuts 169 (FIG. 4). This construction permits the guide plate 5 to be moved transversely to the longitudinal axis of the base 3, guided by the channels 149 and shoulders 45, and lock into a selected position. Accordingly, the location of drill bit portion 135A of the drill aperture 135 with respect to the middle section 13 of the base 3 and with respect to the width of the workpiece W can be adjusted. As a result, the jig 1 allows a user change the dimensions of the jig to accommodate the workpiece W and desired mortise location. The guide plate 5 also has indicator scales 155 adjacent to the indicator slots 147. The values on the indicator scales 155 correspond to the distance from the centerline portion of the drill bit portion 135A of the drill aperture 135 to the front face 19 of the middle section 13.

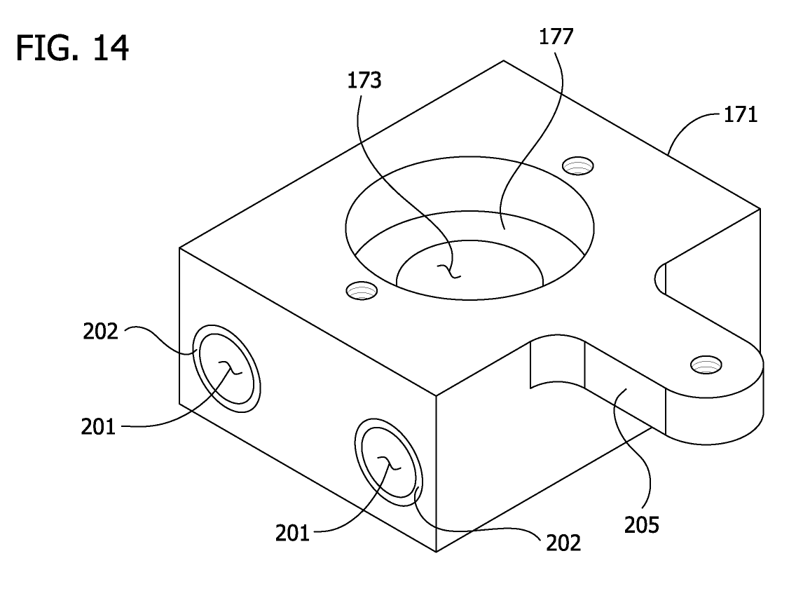

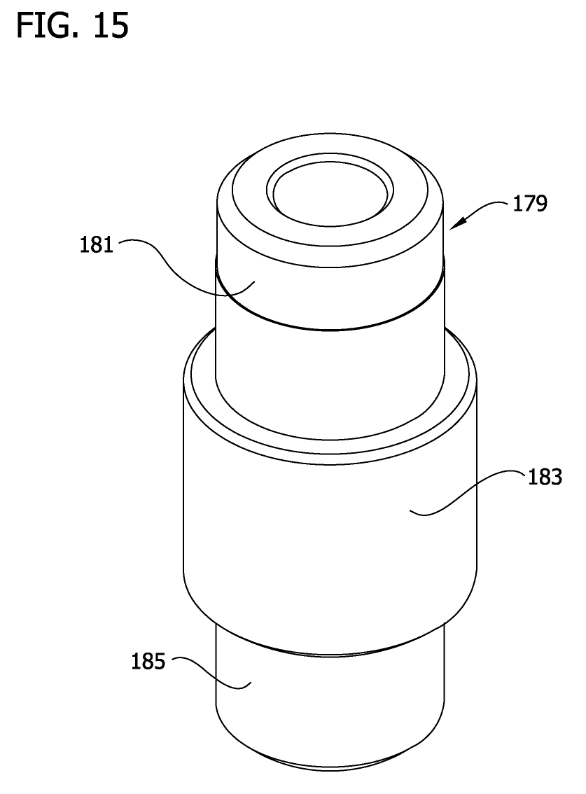

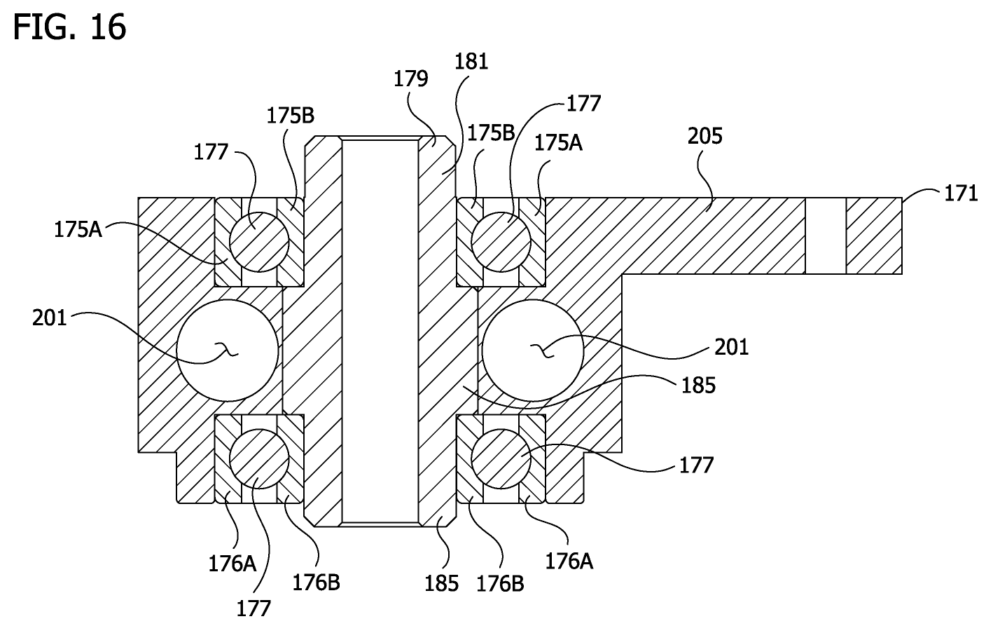

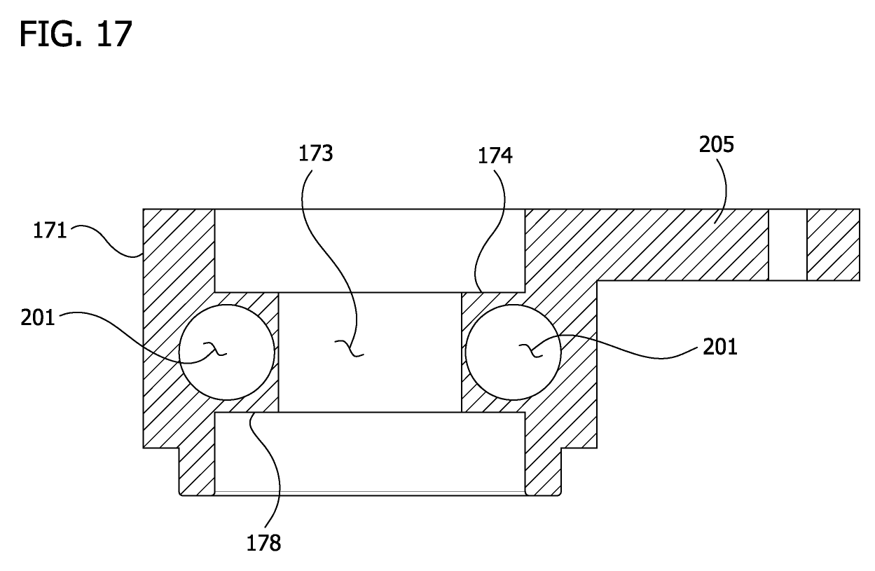

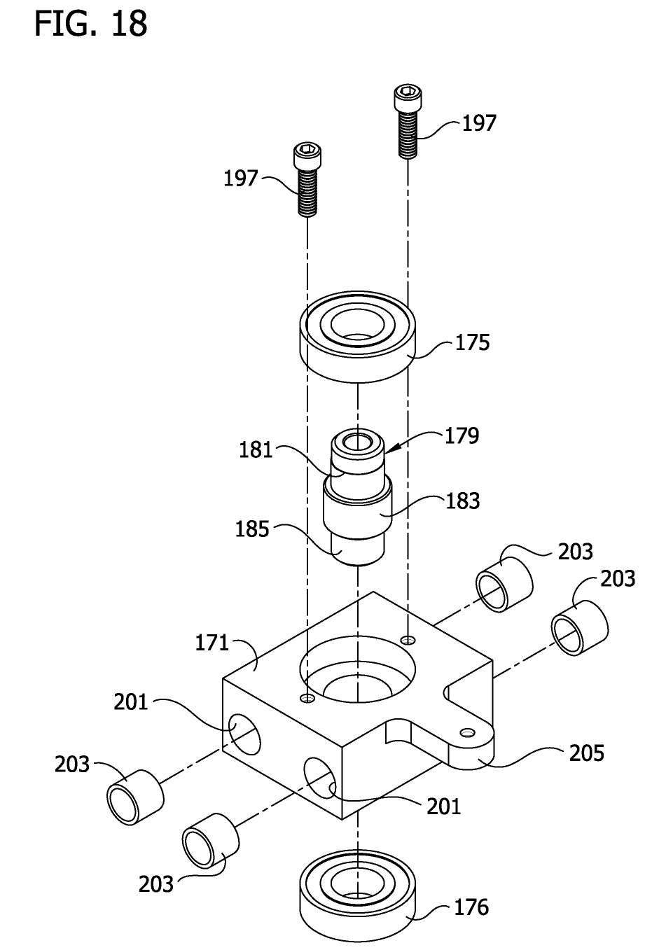

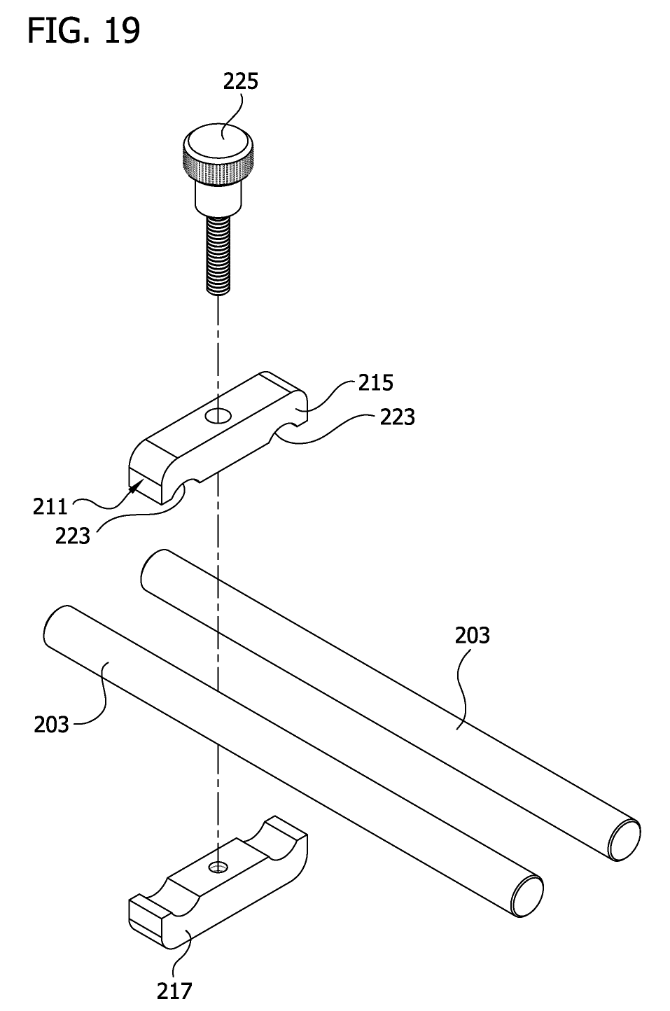

Referring to FIGS. 3 and 14-19, the guide assembly 7 includes guide 171 having a generally cubical shape and an opening 173. A pair of bearings 175, 176 are received inside the opening 173 (see FIGS. 17 and 18). The bearings 175, 176 are of conventional construction having annular outer race members 175A, 176A, annular inner race members 175B, 176B and ball bearings 177 (only two are illustrated) disposed in a race defined by the members (175A, 175B and 176A, 176B). The inner race members 175B, 176B are capable of rotation with respect to the outer race members 175A, 176A. It will be understood that other types of bearings may be used within the scope of the present invention.

The top bearing 175 rests on an annular ledge 174 inside the top of the opening 173 and has a releasable friction fit with the guide 171 in the opening. The bottom bearing 176 engages a guide shoulder 178 and is also held by a friction fit in the opening 173. A bushing 179 is received in the bearings 175, 176 releasably mounting the bushing to the guide 171. The bushing 179 has a top section 181, a middle section 183 and a bottom section 185. The outer diameter of the middle section 183 is larger than the top and bottom sections 181, 185. The outer diameters of the top and bottom sections 181, 185 are sized to fit inside the inner race members 175B, 176B of the bearings 175, 176. The fit between the bushing 179 and the inner race members 175B, 176B allows the bushing and inner race members to rotate conjointly under a rotational force generated by the drilling tool T. The bushing 179 partially extends above and below the guide 171. Hex screws 197 are threaded into the guide 171 and hold the bearing 175 against being moved out of the opening 173 (FIG. 18). The bushing 179 can be removed and replaced with another bushing having a different inner diameter to accommodate different size drill bits. Standard drill bit sizes of ⅜″, ¼″ and ½″ are the most common, however, a bushing suitable for any size drill bit is contemplated.

A pair of passages 201, located on either side of the opening 173, pass through the guide 171 in a direction parallel to the longitudinal axis of the guide. Low-friction bushings 202 are received in opposite ends of the passages 201. An arm 205 projects from one side of the guide 171. The arm 205 is configured for attaching the guide 171 to the actuator 9, as will be explained later in greater detail. Rails 203 allow the guide 171 to slide along the rails (see FIGS. 6 and 18). The slotted blocks 145 receive the ends of the rails 203 in a press fit connection and act as end stops for the guide 171 as the guide moves on the rails. The blocks 145 attach to the guide plate 5 by hex screws 207 which engage corresponding bores in the guide plate and the blocks (see FIG. 13). In the preferred embodiment the rails 203 are made of a shafting material, however, it is envisioned that a single rail and other suitable materials can be used within the scope of the invention.

Referring to FIGS. 3, 5 and 19, a stop 211 is configured to be selectively positionable along the rails 203 in order to shorten the distance the guide 171 can travel. The stop 211 includes a clamp collar comprising a first (top) clamp member 215 and a second (bottom) clamp member 217. Each clamp member 215, 217 has a pair of recesses 223 positioned and shaped to receive part of the rails 203. The stop 211 also includes a set screw 225 to lock the stop at a selected position along the rails 203. The set screw 225 passes through an opening in the first clamp member 215, between the rails 203 and then into a threaded opening in the second clamp member 217. Accordingly, the set screw 225 can be loosen and the stop 211 slid along the rails 203 to select the travel of the guide and hence the length of the mortise being cut in the workpiece W. The position of the stop 211 can be set using a scale 227 affixed to the guide plate 5.

Referring to FIGS. 3 and 6, the actuator 9 comprises a linkage capable of being manipulated to move the guide 171 along the rails 203 in a reciprocating motion. A first linkage arm 231 (broadly, a “lever”) is pivotally connected to one of the blocks 145 at a first end. At one end, the second linkage arm 235 pivotally attaches to the first linkage arm 231. At the other end, the second linkage arm 235 is connected to the arm 205 on the guide 171. The linkage arms 231, 235 are connected such that the first linkage arm 231 and the second linkage arm 235 connect at a 90-degree angle when the guide 171 is positioned generally in the middle of the rails 203. A handle 241 is connected to a second end 243 of the first linkage arm 231. Grasping the handle 241 and rocking the first linkage arm 231 back and forth will produce reciprocating movement of the guide 171 along the rails 203. The length of travel (and hence the length of the mortise) is defined by one of the blocks 145 and the stop 211. The stop can be entirely removed for the maximum travel length.

The linkage forms a 4-bar linkage system. The 4-bar linkage system comprises a first bar created by the portion of the first linkage arm 231 between the pivot connections at the first end 233 and the pivot connection with the second linkage arm 235. A second bar comprises the second linkage arm 235. A third bar operates as a slider, and comprises the arm 205 and the guide 171. The rails 203 function as a fourth bar (frame). This four bar linkage allows the guide 171 to slide along the rails 203 in response to the actuation of the first linkage arm 231. A lever arm created by the portion of first linkage arm 231 between the pivot connection with the second linkage arm 235 and the handle 241 provides the necessary moment to actuate the linkage. While the preferred embodiment of this invention incorporates the 4-bar linkage mechanism to move the guide, it is contemplated that other forms of actuators could be used within the scope of the invention.

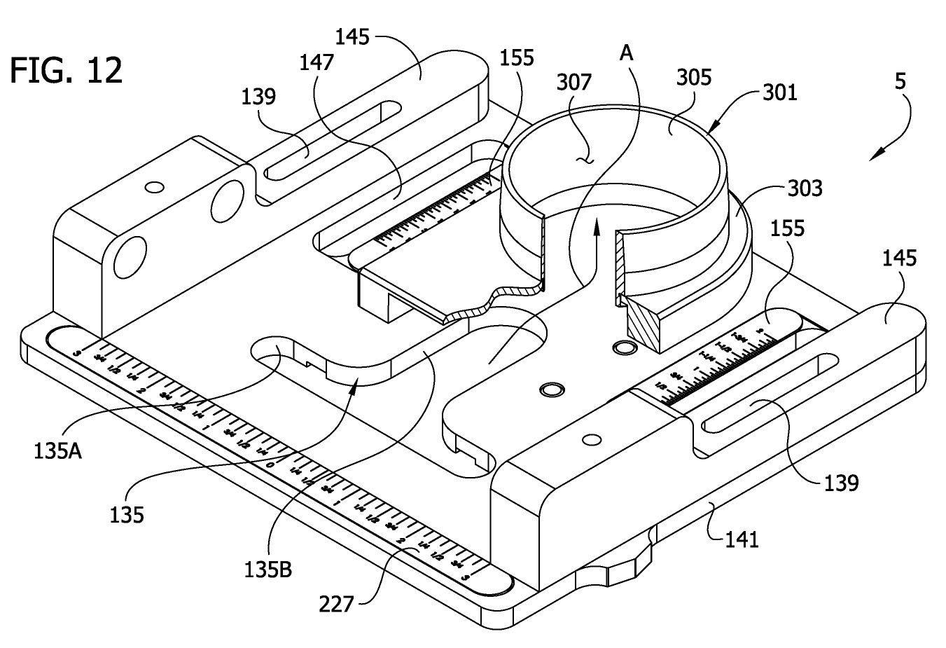

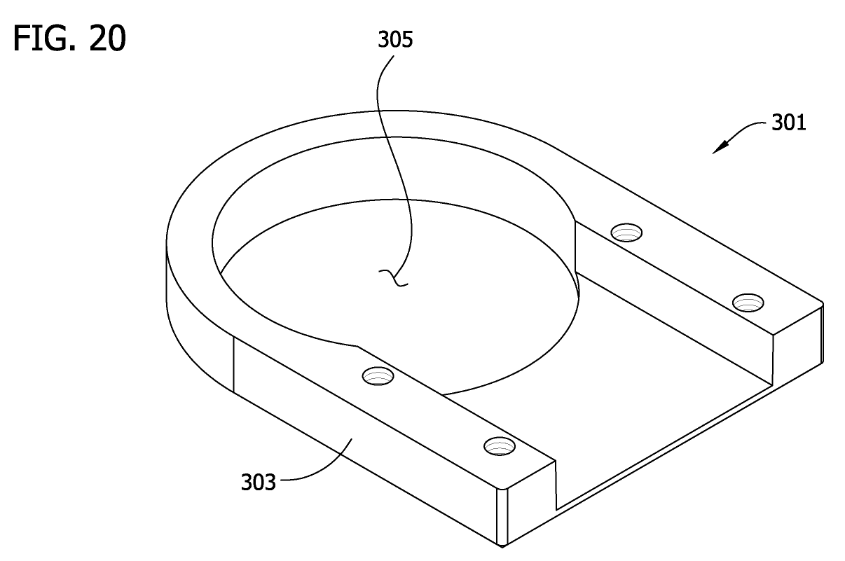

A vacuum hood, indicated generally at 301, has a body 303 with a circular opening 305 (see FIGS. 12 and 20). The circular opening in combination with the top face of the guide plate 5 defines a plenum 307. The hood 301 is positioned on the guide plate 5 such that the plenum 307 partially extends over the vacuum passage portion 135B of the T-shaped drill aperture 135. A path indicated by arrow A is established for drawing wood shavings from the space under the front edge margin of the guide plate 5 to a vacuum line (not shown) connected to the hood 301 over the opening 305. While the illustrated hood 301 represents the preferred embodiment it is understood that different constructions can be used.

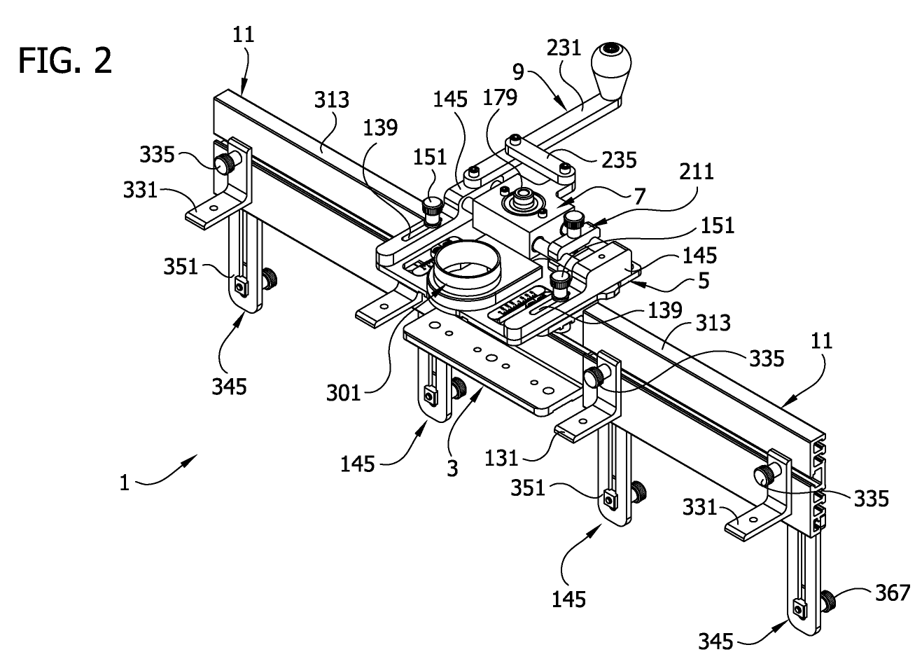

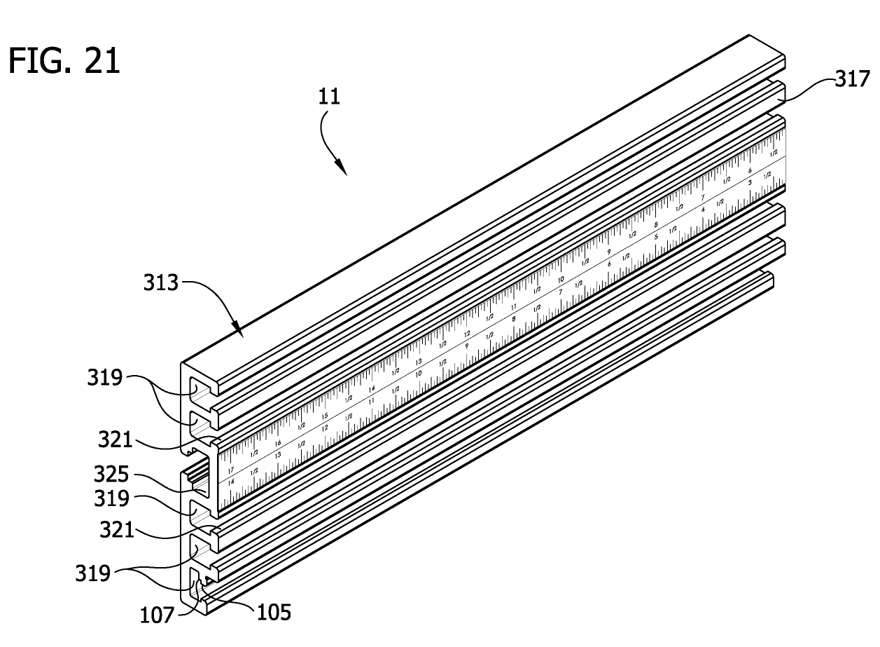

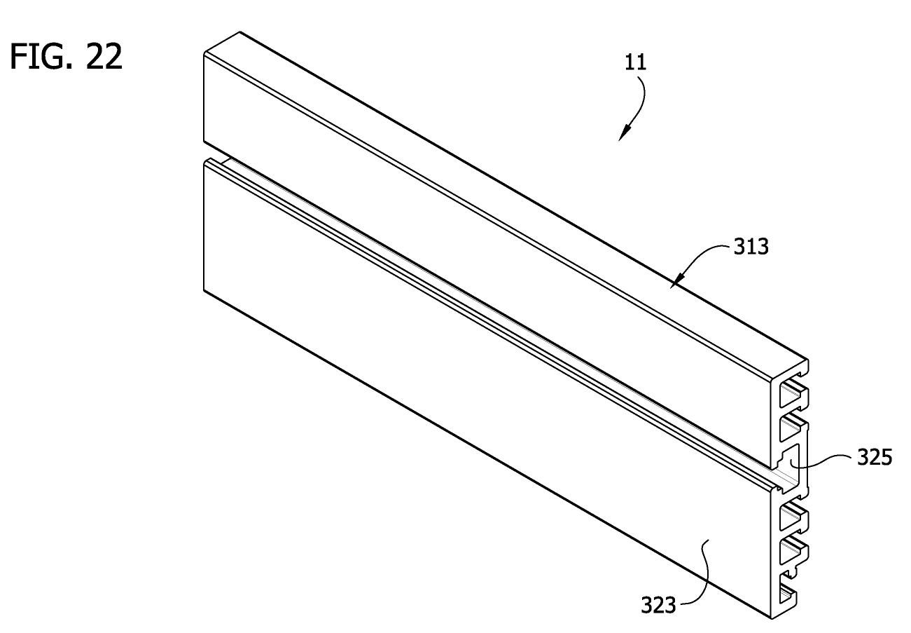

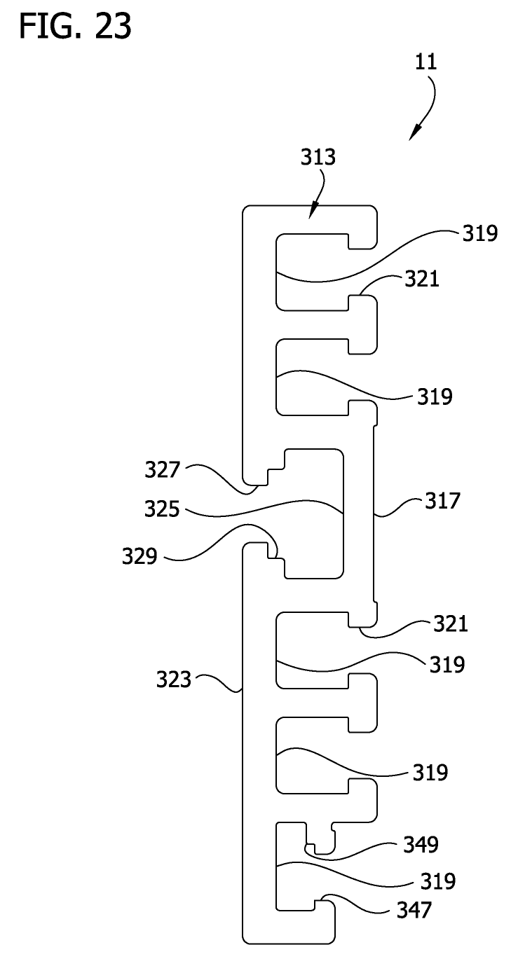

In cases where a larger support surface is required, the extension assembly 11 is provided for attachment next to the base 3 (see FIGS. 1, 2 and 21-25). The extension assembly 11 includes extensions 313 having a similar configuration to the configuration disclosed for the middle section 13 of the base 3. Accordingly, the extensions 313 have a front face 317 with vertically spaced channels 319 extending lengthwise across the extension. Each channel 319 has a lip 321 extending partially over the channel. The channels 319 on the extensions 313 align with the channels 21 on the base 3 to extend the channels 21 longitudinally across the extensions. A back face 323 of the planar member 315 also has a channel 325 with a lip 327 and a shoulder 329 both extending partially over the channel (see, FIG. 23). The channel 325 on the back face 323 of the extension 313 aligns with the channel 31 on the back face 27 of the base 3 extending channel 31 longitudinally across the extension 313.

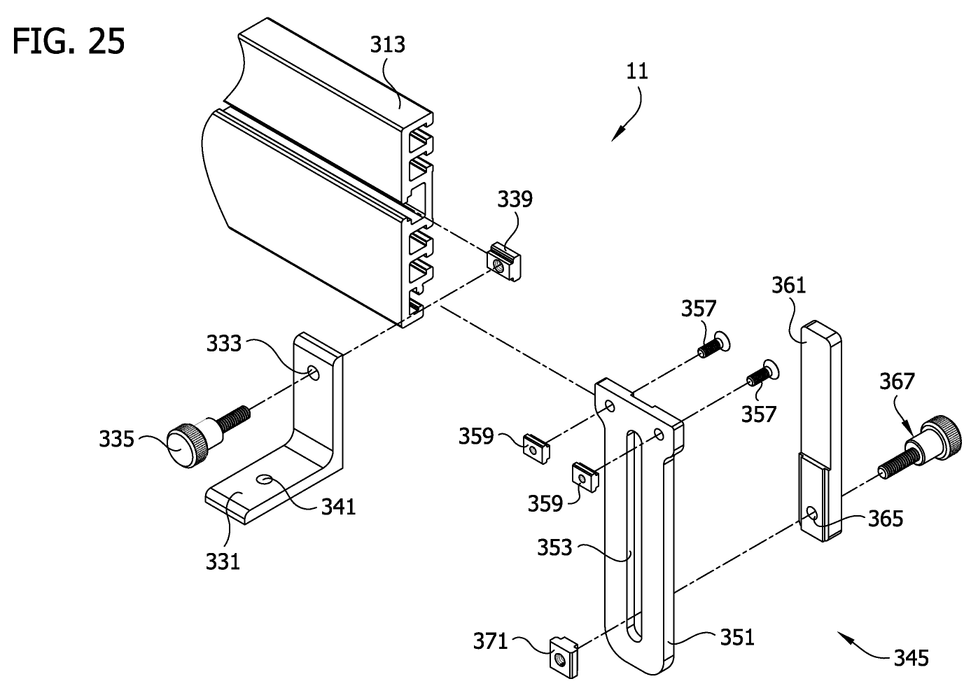

The extensions are located next to the base 3 by attaching the extensions 313 to the workbench such that an edge of the extension abuts an edge of the base. The channel 325 on the back face 323 of the extension 313 aligns with the channel 31 on the back face 27 of the middle section 13 of the base 3 to properly position the extension next to the base. L-brackets 331 provide the means for attaching the extensions 313 to the workbench (see, FIG. 25). A first hole 333 in the L-bracket 331 receives an extension set screw 335 configured to slide in the channel 31. The set screw 335 extends through the first hole 333 in the L-bracket 331 and threads with the extension nut 339. The extension nut has a sufficient size to extend past the lip 327 and shoulder 329 in the channel 325 to fit securely within the channel. The bracket 331 has a second hole 341 on the opposite section providing a means for attaching the extension assembly 11 to the workbench or a similar work support.

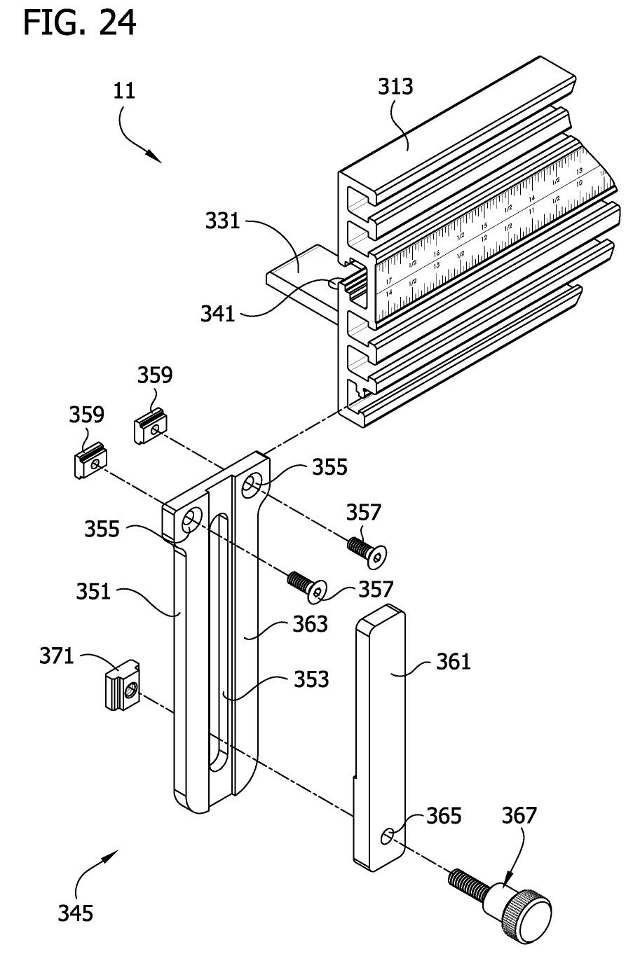

The channel 319 at the bottom of the extension 313 is provided for attaching a workpiece support, generally indicated at 345, to the extension (FIG. 24). The workpiece support 345 comprises an elongate attachment member 351 having a longitudinal center slot 353 running substantially along the length of the attachment member. A pair of holes 355 are positioned at the top of the attachment member 351 and on either side of the slot 353. The holes 355 receive support screws 357. Support nuts 359 engage the threads of the support screws 357. The support nuts 359 have a sufficient size to extend past the lip 347 and shoulder 349 in the channel 343 to fit securely within the channel, securing the workpiece support 345 to the extension 313. The support nuts 359 are also configured for sliding engagement with channel 343 to selectively position the workpiece support 345 along the extension 313.

An elongate contact member 361 engages a front face 363 of the attachment member 351. The contact member 361 has a bore 365 at the bottom end. The bore 365 aligns with the center slot 353 for receiving a set screw 367. The set screw extends through the bore 365 and the center slot 353 and threads with a clamping nut 371. The upper edge of each contact member 361 provides a platform for the workpiece W to rest on when the workpiece is positioned in the jig 1. The clamping nut 371 can be loosened to permit the contact member 361 to be slid up the center slot 353 to a selected position as required by the dimensions of the individual workpiece W.

Operation of the mortising jig 1 is as follows. First, the workpiece W must be located in the jig 1. To do so, the squaring plate 53 is positioned on the base 3 depending on the size of the workpiece W and the desired location of the mortise using the scale 71. The workpiece W is positioned in the jig 1 against the base 3 and the alignment edge 59 of the squaring plate 53. The workpiece W is then clamped to the jig 1 with a suitable clamping device (e.g., C-clamp). If necessary, the workpiece W will rest on the contact members 361 to provide additional support.

Next the guide plate 5 is adjusted, relative to the base 3, to accommodate the size of the workpiece W and the desired location of the mortise. The set screws 153 are loosened, permitting the guide plate 5 to slide transversely to the longitudinal axis of the base 3. The indicator scales 155 provide a measurement of the distance of the drill bit portion 135A of the drill aperture 135 from the front face 19 of the base 3. Once the selected position is chosen, the set screws 151 can be tightened to lock the guide plate 5 in place. The stop 211 can then be adjusted to a desired position along the rails 203 using the scale 227 or removed completely to set the travel length of the guide 171 and the length of the mortise. Now the drilling tool T, and more specifically the mortising drill bit on the drilling tool, can be located by the guide assembly 7 over the drill aperture 135. This is done by inserting the drill bit into the bushing 179.

The mortise is then cut by grasping the handle 241 of the actuator 9 and rocking the first arm linkage 231 back and forth. This will cause the guide assembly 7 to slide along the rails 203 in a reciprocating motion such that the mortising drill bit moves along the drill bit portion 135A and engages the workpiece W ultimately removing enough material from the workpiece to form the mortise. Shavings and debris from the workpiece W can be drawn by a vacuum through the drill aperture 135 and out through the vacuum hood opening 305. It will be necessary to maintain control of the drilling tool T while rocking the actuator so that drilling tool T can be moved down within the mortise of workpiece W to cut the mortise to a sufficient depth.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is clamed is:

1. A jig for cutting a mortise in a workpiece using a drilling tool having a mortising drill bit, the jig comprising:
a guide plate;
a guide assembly for locating the drilling tool, the guide assembly comprising,
at least one rail supported by the guide plate,
a guide mounted on the rail for movement along the rail relative to the guide plate, the guide having an opening therein for receiving and positioning the drilling tool, and
a bushing within the opening in the guide, the bushing being mounted on the guide for rotation relative to the guide plate with the mortising drill bit of the drilling tool.

2. The jig as set forth in claim 1 wherein the bushing defines a hole sized to have a small clearance fit with the mortising drill bit whereby the bushing and drill bit rotate substantially conjointly.

3. The jig as set forth in claim 2 wherein the bushing is releasably mounted on the guide

4. The jig as set forth in claim 3 wherein the bushing constitutes a first bushing and the jig further comprises a second bushing adapted for releasable mounting on the guide, the second bushing have a hole having a diameter different than a diameter of the first bushing to accommodate drilling tool mortising bits having different mortising drill bit sizes.

5. The jig as set forth in claim 1 further comprising a base mounting the guide plate thereon.

6. The jig as set forth in claim 5 wherein the guide plate is mounted for sliding adjustment relative to the base for positioning the guide.

7. The jig as set forth in claim 6 further comprising bearings mounted on one of the guide plate and the base, and slots in the other of the guide plate and base, the bearings being received in the slots for guiding movement of the guide plate relative to the base.

8. The jig as set forth in claim 7 further comprising a scale associated with one of the guide plate and base, and a pointer associated with the other of the guide plate and base, the scale and pointer being arranged to show the relative position of the guide plate and base.

9. The jig as set forth in claim 8 wherein the pointer is on the bearing.

10. The jig as set forth in claim 6 further comprising a set screw for releasably locking the guide plate and base together.

11. The jig as set forth in claim 1 further comprising an extension attached to the base and extending outward from the base for expanding the surface for positioning the workpiece

12. The jig as set forth in claim 11 wherein the extension further comprises at least one channel for securing a workpiece support to the jig.

13. The jig set forth in claim 12 wherein the at least one channel further comprises a lip partially overhanging the channel for securing the workpiece support to the jig.

14. The jig set forth in claim 13 in combination with the workpiece support.

15. The jig as set forth in claim 1 further comprising an actuator operatively connected to the guide and to the guide plate for moving the guide along the rail.

16. The jig as set forth in claim 15 wherein the actuator, guide and rail define a rocker-slider mechanism.

17. The jig as set forth in claim 16 wherein the actuator comprises a lever pivotally mounted on the guide plate and a link pivotally connected to the lever and to the guide.

18. The jig as set forth in claim 1 further comprising a stop mounted on the rail adapted for being selectively fixed to the rail at different locations to set a travel distance of the guide on the rail.

19. The jig as set forth in claim 1 further comprising a vacuum chute on the guide plate.

20. The jig set forth in claim 1 further comprising a squaring plate attached to the base, the squaring plate providing a backstop for positioning the workpiece.

21. A jig for cutting a mortise in a workpiece using a drilling tool having a mortising drill bit, the jig comprising:
a guide plate;
a guide assembly for locating the drilling tool, the guide assembly comprising,
at least one rail mounted on the guide plate, and
a guide mounted on the rail for movement along the rail relative to the guide plate, the guide having an opening therein for receiving and positioning the mortising drill bit;
a guide actuator comprising a lever pivotally mounted on the guide plate and a link connecting the lever to the guide whereby rocking motion of the lever produces linear reciprocating motion of the guide on the rail.

22. The jig as set forth in claim 21 wherein the link is pivotally connected to the lever and to the guide.

23. The jig set forth in claim 22 wherein the actuator, rail and guide define a rocker-slider mechanism.

24. The jig set forth in claim 23 further comprising a handle attached to the lever.

25. The jig set forth in claim 24 further comprising a bushing mounted in the opening in the guide for rotation with the mortising drill bit relative to the guide.

26. The jig as set forth in claim 21 further comprising a base mounting the guide plate thereon.

27. The jig as set forth in claim 26 wherein the guide plate is mounted for sliding adjustment relative to the base for positioning the guide.

28. The jig as set forth in claim 27 further comprising bearings associated with one of the guide plate and the base, and slots associated with the other of the guide plate and base, the bearings being received in the slots for guiding movement of the guide plate relative to the base.

29. The jig as set forth in claim 28 further comprising a scale associated with one of the guide plate and base, and a pointer associated with the other of the guide plate and base, the scale and pointer being arranged to show the relative position of the guide plate and base.

30. The jig as set forth in claim 29 wherein the pointer is on the bearing.

31. The jig as set forth in claim 27 further comprising a set screw for releasably locking the guide plate and base together.

32. The jig as set forth in claim 21 further comprising an extension attached to the base and extending outward from the base for expanding the surface for positioning the workpiece

33. The jig as set forth in claim 32 wherein the extension further comprises at least one channel for securing a workpiece support to the jig.

34. The jig set forth in claim 33 wherein the at least one channel further comprises a lip partially overhanging the channel for securing the workpiece support to the jig.

35. The jig set forth in claim 34 in combination with the workpiece support.

36. The jig as set forth in claim 21 further comprising a stop mounted on the rail adapted for being selectively fixed to the rail at different locations to set a travel distance of the guide on the rail.

37. The jig as set forth in claim 21 further comprising a vacuum chute on the guide plate.

38. The jig set forth in claim 21 further comprising a squaring plate attached to the base, the squaring plate providing a backstop for positioning the workpiece.

39. An adjustable jig for cutting a mortise in a workpiece using a drilling tool having a mortising bit, the jig comprising:
a base;
an adjustable guide plate;
a guide assembly supported by the adjustable guide plate for locating the mortising drill bit of the drilling tool, the guide assembly comprising,
rails mounted on the guide plate, and
a guide mounted on the rail for movement along the rail relative to the guide plate, the guide having an opening therein for receiving and positioning the mortising drill bit;
the guide plate being mounted on the base for movement of the guide plate relative to the base and adapted for releasable attachment to the base at selected locations whereby the guide plate and guide assembly can be positioned with respect to the base.

40. The adjustment jig set forth in claim 39 wherein the guide plate comprises a set screw for releasably fixing the guide plate and the base.

41. The jig as set forth in claim 39 further comprising bearings mounted on one of the guide plate and base, and slots in the other of the guide plate and base, the bearings being received in the slots for guiding movement of the guide plate relative to the base.

42. The jig as set forth in claim 41 further comprising a scale associated with one of the guide plate and base, and a pointer associated with the other of the guide plate and base, the scale and pointer being arranged to show the relative position of the guide plate and base.

43. The jig as set forth in claim 42 wherein the pointer is on the bearing.
